(19) United States
(12) Patent Application Publication
(10) Pub. No.: US 2008/0110581 A1
(43) Pub. Date: May 15, 2008

(54) Safety mechanism for window blind

(76) Inventor: Tzong-Fu Lin, Taipei (TW)

Correspondence Address: BRUCE H. TROXELL, SUITE 1404, 5205 LEESBURG PIKE, FALLS CHURCH, VA, 22041, US

(21) Appl. No.: 11/599,632

(22) Filed: Nov. 15, 2006

(51) Int. Cl. E06B 9/26

(52) U.S. Cl. 160/178.2; 160/178.1 R

(57) ABSTRACT

A safety mechanism for a window blind includes a fixing member mounted to a head rail of the window blind, and a clamping member connected to a second end of a lift cord of the window blind. The clamping member includes a C-shaped ring portion normally compressively clamped around a protruded portion of the fixing member. When the second end of the lift cord is subjected to an exceeded downward load, the C-shaped ring portion is forced to separate from the protruded portion and accordingly disengages the lift cord from the head rail. Therefore, an accident possibly caused by a lift cord wound around and tightened against a child's neck may be avoided to ensure safe use of the window blind.

### FIELD OF THE INVENTION

The present invention relates to a safety mechanism, via which a lift cord and a head rail of a window blind are detachably connected to one another, such that when the lift cord is subjected to an exceeded load, it is automatically separated from the head rail to avoid any possible accident.

### BACKGROUND OF THE INVENTION

FIG. 1 is a front perspective view of a conventional Venetian blind, which includes a head rail 1, a blind 2, and a plurality of lift cords 3. The head rail 1 is internally divided into a front chamber 4 and a rear chamber 5. A lift lock 6 and a cord pulley 7 are mounted in the rear chamber 5. The lift cord 3 includes a first end 8 and a second end 9. The first end 8 of the lift cord 3 is passed through the lift lock 6 and the cord pulley 7, so as to control the blind 2 via the lift lock 6 for the blind 2 to be lifted to any desired position. The second end 9 of the lift cord 3 is wound around an exterior of the blind 2 to form a loop and then connected to the head rail 1. Whereby, when the first end 8 of the lift cord 3 is pulled, the second end 9 wound around the blind 2 is moved upward to lift the blind 2.

Since the second end 9 of the lift cord 3 is wound around the exterior of the blind 2 to form a loop, it is very possible that a small child is not aware of the potential danger and extends its head through the loop. In the event the first end 8 of the lift cord 3 is pulled at this point, the second end 9 would be moved upward to dangerously tighten against the child's neck and causes an accident. Since there is not any safety mechanism provided on the conventional Venetian blind for timely separating the second end 9 of the lift cord 3 from the head rail 1 to avoid the above-mentioned accident, the conventional Venetian blind with the above-described structure forms a potential danger in a general house.

It is therefore tried by the inventor to develop a safety mechanism for window blind to eliminate the above-mentioned drawbacks.

### SUMMARY OF THE INVENTION

A primary object of the present invention is to provide a safety mechanism for window blind, so that any possible accident caused by a lift cord of the window blind wound around and tightened against a child's neck may be avoided to ensure the safe use of the window blind.

To achieve the above and other objects, the safety mechanism for window blind according to the present invention includes a fixing member mounted to a head rail of the window blind, and a clamping member connected to a second end of a lift cord of the window blind. The clamping member includes a C-shaped ring portion normally compressively clamped around a protruded portion of the fixing member. When the second end of the lift cord is subjected to a load exceeded a predetermined value, such as 3 kgs, the C-shaped ring portion is forced to separate from the protruded portion and accordingly disengages the lift cord from the head rail, so that the window blind may be safely used without the risk of causing an accident due to a lift cord wound around a child's neck.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a front perspective view of a conventional Venetian blind;

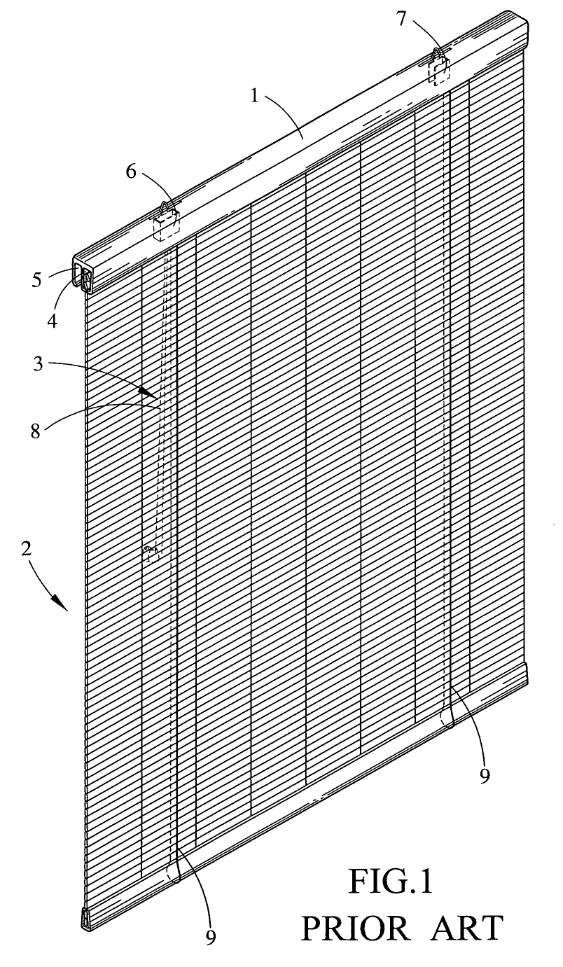

FIG. 2 is a front perspective view of a window blind with safety mechanism according to the present invention;

FIG. 3 is an enlarged view of the circled area 19 in FIG. 2;

FIG. 4 is a rear perspective view of the window blind of FIG. 2;

FIGS. 5 and 6 are exploded and assembled perspective views, respectively, of the safety mechanism for window blind according to the present invention; and

FIGS. 7 and 8 show the operation of the safety mechanism for window blind according to the present invention.

### DETAILED DESCRIPTION OF THE PREFERRED EMBODIMENTS

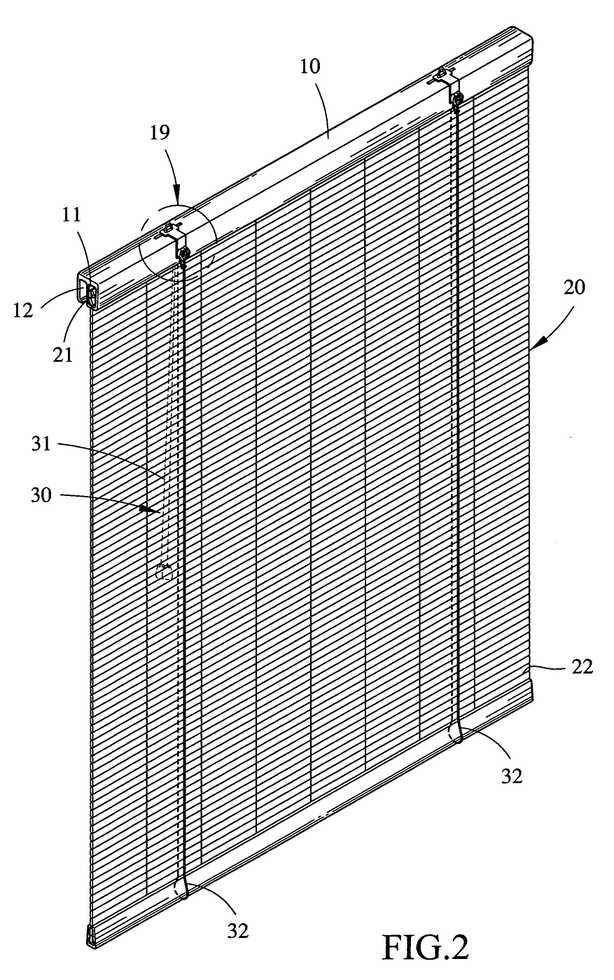

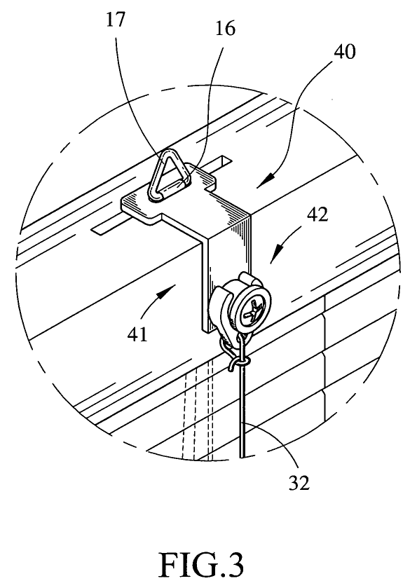

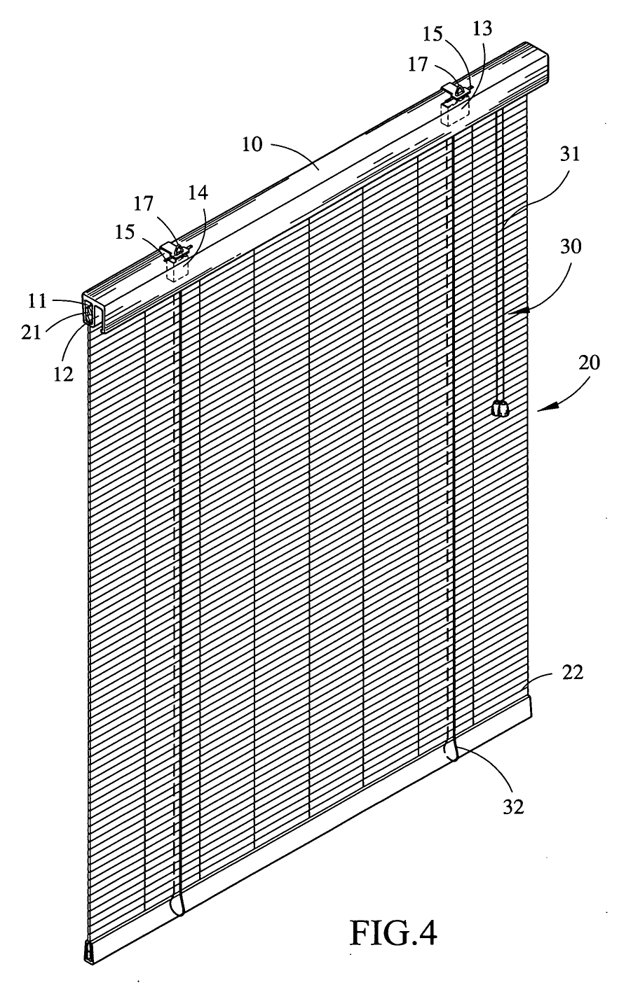

Please refer to FIGS. 2 and 4 that are front and rear perspective views, respectively, of a window blind with safety mechanism according to the present invention, and to FIG. 3 that is an enlarged view of the circled area 19 in FIG. 2. As shown, the window blind includes a head rail 10 for mounting to a window frame, a blind 20, a plurality of lift cords 30 for lifting or lowering the blind 20 to different positions, and at least one safety mechanism 40.

The head rail 10 is internally divided into a front chamber 11 and a rear chamber 12. A first end 21 of the blind 20 is received in the front chamber 11 to connect to the head rail 10. A second end 22 of the blind 20 is hung from the hear rail 10. As can be more clearly seen from FIG. 4, a sliding assembly is mounted in the rear chamber 12 of the head rail 10. The sliding assembly includes a lift lock 13 and a pulley 14. The head rail 10 is provided on a top thereof with two long holes 15, via which two supporting members 16 are inserted to separately associate with the lift lock 13 and the pulley 14. A hanger 17 is extended through and connected to a top of each supporting member 16, so that the head rail 10 may be hung to the window frame via the hangers 17.

Each of the lift cords 30 has a first end 31 and a second end 32. The first end 31 of the lift cord 30 may control via the lift lock 13 to lift or lower the blind 20 to a desired position. The second end 32 of the lift cord 30 is passed through the lift lock 13 and the pulley 14 to vertically extend around an exterior of the blind 20. When the first end 31 of the lift cord 30 is pulled, the second end 32 is brought to move at the same and accordingly lifts or lowers the blind 20, so that light is admitted into a room or blocked, respectively.

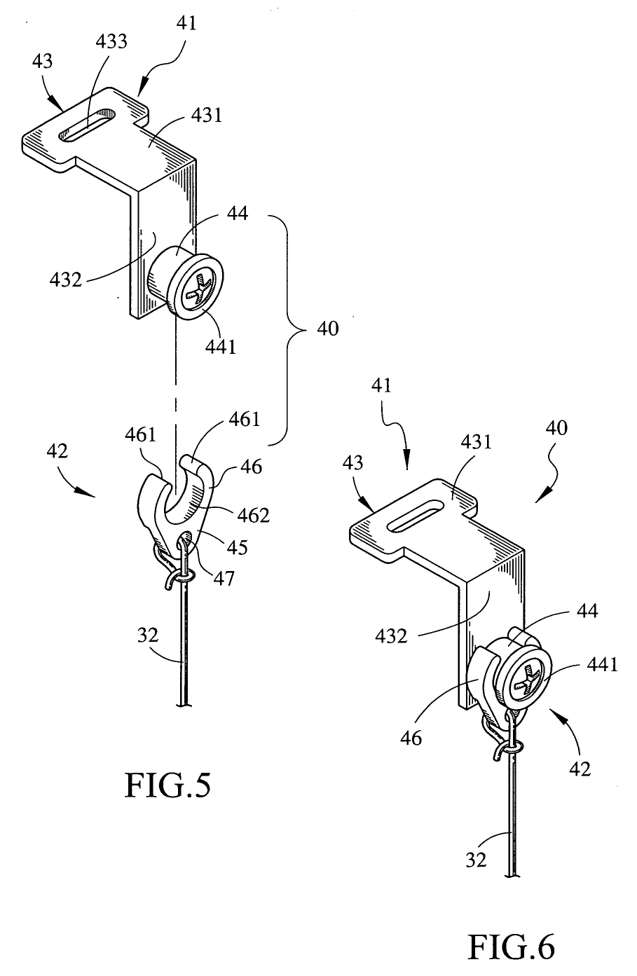

Please refer to FIGS. 5 and 6. The safety mechanism 40 includes a fixing member 41 and a clamping member 42. The fixing member 41 is an integral body having a connecting portion 43 and a protruded portion 44. The connecting portion 43 includes a horizontal section 431 and a vertical section 432. The horizontal section 431 is formed of a long hole 433, via which the supporting member 16 may be inserted into the long hole 15 to connect to the lift lock 13 or the pulley 14, so that the fixing member 41 of the safety mechanism 40 is connected to the head rail 10, as shown in FIG. 3.

The clamping member 42 is an integrally formed member having a connecting end 45 and a C-shaped ring portion 46. A terminal of the second end 32 of the lift cord 30 is extended through and firmly secured to a through hole 47 on the connecting end 45. The C-shaped ring portion 46 defines a space 462 having a diameter for fitly receiving the protruded portion 44 of the fixing member 41 therein. A flange 441 is provided around an outer end of the protruded portion 44 to prevent the C-shaped ring portion 46 from sliding away from the protruded portion 44.

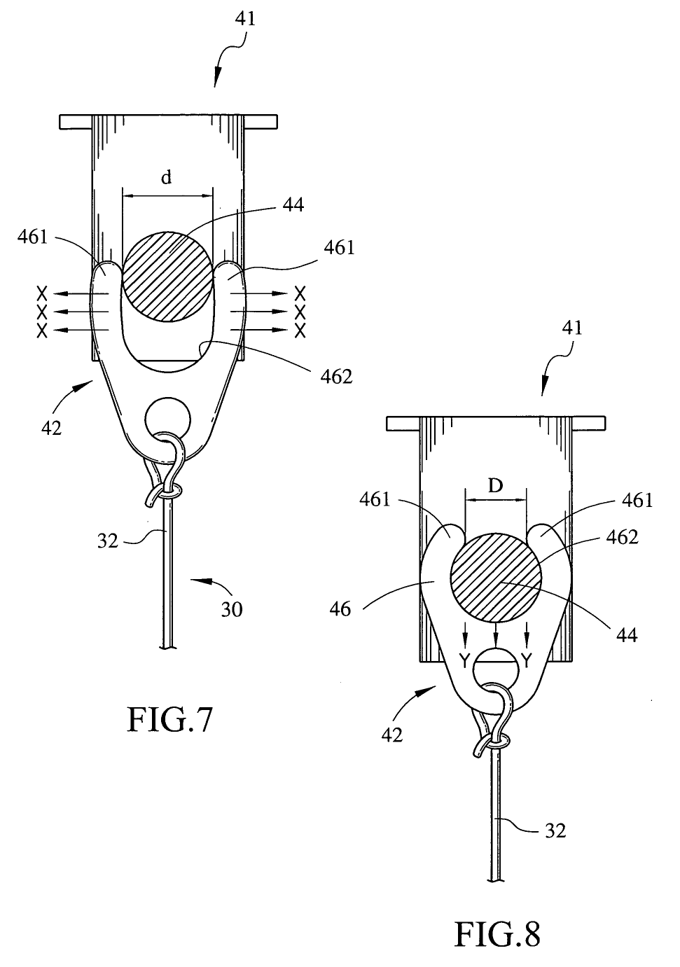

Please refer to FIGS. 7 and 8. The C-shaped ring portion 46 has two free ends 461 that normally define a distance D between them. The distance D is slightly smaller than a diameter d of the protruded portion 44 of the fixing member 41. Therefore, the clamping member 42 may be upward pushed to enclose the protruded portion 44 in the space 462 defined by the C-shaped ring portion 46. At this point, the C-shaped ring portion 46 would apply a predetermined pressure around the protruded portion 44 to thereby firmly hold the clamping member 42 to the fixing member 41.

When the C-shaped ring portion 46 is upward pushed against the protruded portion 44 therein, the two free ends 461 of the C-shaped ring portion 46 are subjected to radially outward pressure, as indicated by the arrows X in FIG. 7, and be pushed open, allowing the protruded portion 44 to move into the space 462.

When the second end 32 of the lift cord 30 is subjected to a downward load exceeded a predetermined value, such as 3 kgs, the C-shaped ring portion 46 of the clamping member 42 is also subjected to a downward force indicated by the arrows Y in FIG. 8, and moves downward. At this point, the space 462 in the C-shaped ring portion 46 is subjected to sideward pressure from the protruded portion 44 to open the two free ends 461 of the C-shaped ring portion 46, allowing the C-shaped ring portion 46 to downward slide away from the protruded portion 44 and thereby separate the clamping member 42 from the fixing member 41. As a result, the second end 32 of the lift cord 30 is disengaged from the head rail 10 to avoid an accident caused by the lift cord 30 wound around a child's neck.

The safety mechanism 40 of the present invention may also be applied to all types of window blinds having a blind that can be vertically lifted or lowered, such as a roller blind, a Venetian blind, a Roman blind, etc.

What is claimed is:

1. A safety mechanism for window blind, said window blind including a head rail, a blind connected to said head rail, a lift lock mounted in said head rail for controlling said blind to stop at a desired lifted position, and a plurality of lift cords having a first and a second end, and said first end causing said second end to move via said lift lock; said safety mechanism comprising:
at least one fixing member mounted on an outer surface of said head rail, and having a protruded portion; and
at least one clamping member connected to said second end of said cord, and including a C-shaped ring portion for clamping while applying a predetermined pressure against said protruded portion of said fixing member;
whereby when said second end of said lift cord is subjected to an exceeded downward load, said C-shaped ring portion is forced to separate from said protruded portion, preventing an accident possibly caused by said lift cord being wound around and tightened against a child's neck.

2. The safety mechanism for window blind as claimed in claim 1, wherein said fixing member further includes a connecting portion having a horizontal section and a vertical section, and said protruded portion being connected to said vertical section of said connecting portion.

3. The safety mechanism for window blind as claimed in claim 1, wherein said clamping member further includes a connecting end downward extended from said C-shaped ring portion, said connecting end being formed of a hole, through which said second end of said lift cord is extended to fasten to said clamping member, such that said clamping member may be moved via said lift cord.

4. The safety mechanism for window blind as claimed in claim 1, wherein said protruded portion of said fixing member is provided around an outer end with a flange to prevent said C-shaped ring portion of said clamping member from horizontally sliding out of said protruded portion.

5. The safety mechanism for window blind as claimed in claim 1, wherein said C-shaped ring portion has two spaced free ends, and a distance between said two free ends being smaller than a diameter of said protruded portion.
